(19) United States
(12) Patent Application Publication
(10) Pub. No.: US 2009/0204488 A1
(43) Pub. Date: Aug. 13, 2009

(54) DELIVERING ENTERTAINMENT-ENHANCED CONTENT-RELATED ADVERTISEMENT OVER MULTIMEDIA NETWORKS

(76) Inventor: Malka Leviev-Cohen, Petach (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/030,227

(22) Filed: Feb. 13, 2008

(51) Int. Cl. G06Q 30/00; G06F 17/00

(52) U.S. Cl. 705/14; 463/16

(57) ABSTRACT

A computer implemented method, data processing system, and computer program product for delivering entertainment-enhanced content-related advertisement over multimedia networks This is done by implementing a dedicated data structure that serves as a vehicle between a mediator server and the users. The dedicated multimedia vehicle is loaded with entertaining content from one database and integrated with the advertising content such that the advertising content in context related to the entertaining content. The users are then engaged in an interacting activity relating to the entertainment content and are tacitly exposed to the advertising content and pure advertising as well. The mediator server is capable then of providing the advertiser with targeted information regarding the users.

### TECHNICAL FIELD

The present invention relates to multimedia networks and, more particularly, to delivering targeted advertisements over such networks.

### BACKGROUND OF THE INVENTION

Multimedia networks, such as printed media, the Internet, interactive television and cellular media have been the target of advertisement since the introduction of these technologies. As technology developed, more sophisticated advertisement means have evolved. The evolution in multimedia network advertisement pertains to focusing the advertisements on the target audience in accordance with the fields of interests of specific users. Interactivity which characterizes the multimedia networks environment enables advertisers to track content-related activities of the users and consequently customize the advertisement accordingly.

Cognitive psychological researches now show that implicit advertising is much more effective than explicit advertisement. Pop-up windows, moving pages and banners tend to irritate Web users, and many software tools are now directed at blocking these advertising means. On the contrary, sub conscious messages embedded within non advertising content prove themselves much more appealing to users, specifically in an advertisements rich environment such as the Internet.

US patent application number US20060167747 which is incorporated herein by reference in its entirety discloses a content targeted advertisement system for use in commercial market. The system has user-analysis component to examine user action, and advertisement delivery component determining advertisement to present to user based on user action.

Further, US patent application number US20060190331 which is incorporated herein by reference in its entirety, discloses an advertising item delivery method for cell phone, personal digital assistant.

It would be therefore advantageous to have means for combining implicit advertising within the content presented to users over multimedia networks wherein the advertisement is further related to the activity of the user.

### SUMMARY OF THE INVENTION

The present invention suggests using entertainment enhanced implicit advertisement over multimedia networks, wherein the advertisement is responsive to the content the user is interested at.

In embodiments, a computer implemented method, data processing system, and computer program product for delivering entertainment-enhanced content-related advertisement over multimedia networks is disclosed.

The object of the invention is achieved by implementing a mediator server that is arranged to gather characteristic information pertaining to each and every user on a multimedia network. Then, responsive of the user's request for entertainment content, delivering him or her an entertaining content with advertising content embedded in it such that the advertising content is contextually related to the information gathered from the corresponding user.

It is another object of the present invention to implement a dedicated data structure that serves as a vehicle between the mediator server and the users. The multimedia vehicle may be arranged and designed responsive to the user-related information gathered by the mediator such the “Below the Line” advertising effect is optimized. The users are then engaged in an interacting activity relating to the entertainment content and are implicitly exposed to the advertising content via multimedia network (internet, interactive TV, cellular and any kind of known and unknown media).

In embodiments, the mediator server is capable of providing the advertiser with targeted information regarding the users, their activities, history, preferences and the like. Additionally, the information can be used as analyzed database of different target groups.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a flowchart showing the steps of the method according to some embodiments of the disclosure;

FIG. 2 is a schematic block diagram of the data processing system according to some embodiments of the disclosure;

FIG. 3 is a flowchart showing the steps of an entertainment feature wherein advertisement is embedded thereto according to the present invention; and

FIG. 4 shows an exemplary embodiment for the entertainment enhanced advertisement layout according to the present invention.

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

The present invention discloses a mediator server connected to a multimedia network (such as the Internet) that is arranged to gather characteristic information pertaining to each and every user on a multimedia network. Preferably, information gathering is invoked by the user, responsive to a certain content that is related to the mediator server. Specifically, the user is encouraged to initiate a communication with the mediator server by any available communication means responsive to a content portion related to the mediator server. Then, responsive of the user's request for entertainment content, and after processing the user related information gathered as a result of the user communication, the mediator server delivers the user an entertaining content with advertising content embedded in it such that the advertising content is contextually related to the information gathered from him or her.

In order to implement the present invention, there is provided a dedicated data structure that serves as a vehicle between the mediator server and the users. The multimedia vehicle may be arranged and designed responsive to the user-related information gathered by the mediator such the “Below the Line” advertising effect is optimized. The users are then engaged in an interacting activity relating to the entertainment content and are implicitly exposed to the advertising content.

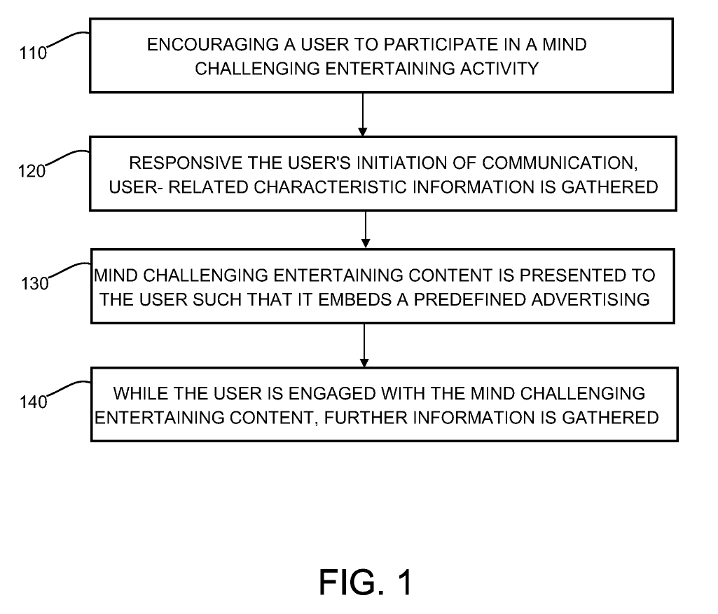

FIG. 1 is a flowchart showing the steps of the method according to some embodiments of the disclosure. The flowchart relates to a computer implemented method for delivering entertainment-enhanced content-related advertisement over multimedia networks. The method may comprise the stage of encouraging a user to participate in a mind challenging entertaining activity 110. Then, responsive the user's initiation of communication, user-related characteristic information is gathered 120. Then, a mind challenging entertaining content is presented to the user such that it embeds a predefined advertising content and wherein the representation of the advertising content is optimized in accordance with the user-related gathered information 130. Optionally, while the user is engaged with the mind challenging entertaining content, further information is gathered 140. Optionally, the information gathered of the user's engagement is reported to advertisers for further optimizing the targeted advertising process.

For example, a user sees an advertisement in a newspaper relating to a specific prize, such as a ski holiday. In order to participate, the user is required to dial a certain phone number. In response, all the information that may be gathered from the user, such as the name of the newspaper he or she was reading, the geographical location, and any further information that may be derived from the phone number regarding the specific user, subject to legal limitations, user is presented. Then, the mediator server is selecting the most effective mind challenging content in order to optimize the advertisement of a specific skiing equipment manufacturer. The user is then presented, on his or her mobile phone with a mind challenging interactive game such as a quiz, relating to skiing sites around the world, and is visually exposed to a specific skiing equipment manufacturer in the course of the game. The representation of the advertisement is tailored to the specific user. The information regarding the specific user may be then forwarded to the specific skiing equipment manufacturer for further engagement.

According to some embodiments of the user related information may be any biographical information that may be retrieved from knowing the user-related phone number that serves as an ID number for the system. This information may be age, sex, residential address, financial situation, employment and the like. In addition, more information may be derived from knowing the specific trigger for the initiation of the communication by the user: a newspaper ad, a cellular ad, a TV ad, an Internet ad and the like. In addition, the means of communication with the mediator server, as chosen by the user may also be used to evaluate the user-related characteristics.

According to some embodiments of the invention, the advertisement content is contextually related to the entertainment content.

According to some embodiments of the invention the entertainment content comprises an interactive game. Thus, while the users are engaged in the game, they are implicitly exposed to the relevant advertising content, which is related to the theme of the game.

According to some embodiments of the invention the stage of presenting users with said entertainment content having the advertisement content embedded thereto is followed by tracking the user's activity in regards to the entertainment content. Thus the mediator may generate a dedicated database comprising relevant information that may be used later in targeted advertising.

According to some embodiments of the invention the stage of tracking the user's activity in regards to the entertainment content is followed by generating reports relating to the user's activities. Thus the mediator may serve as a feedback module providing data as to the effectiveness of the advertisement.

According to some embodiments of the invention, the invention is implemented as a computer program product that comprises a computer usable medium having computer usable program code tangibly embodied thereon, the computer usable program code comprises a computer usable program code for embedding advertisement content into entertainment content and a computer usable program code for presenting users with said entertainment content having the advertisement content embedded thereto.

According to some embodiments of the invention, the invention is implemented as an article of manufacture comprising an electrical signal implementing said computer usable program code for embedding advertisement content into entertainment content and a said computer usable program code for presenting users with said entertainment content having the advertisement content embedded thereto.

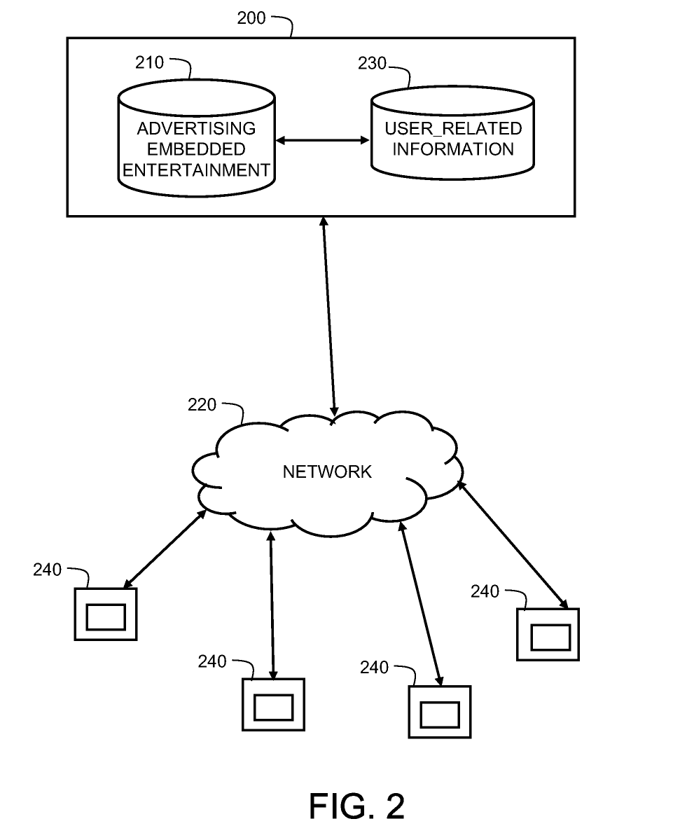

FIG. 2 is a schematic block diagram depicting an embodiment of data processing system for delivering entertainment-enhanced content-related advertisement over multimedia networks. The data processing system comprises a mediator server 200 coupled to a network 220 that may be a cellular phone network, the Internet or any multimedia network that connects to users via computer clients 240 such as mobile phones, PDAs and PCs.

The mediator server 200 comprises a user related information database 230 and an advertisement embedded entertainment content database 210 configured to gather characteristic information pertaining to each and every user on a multimedia network 220. Then, responsive of the user's request for entertainment content, delivering him or her an entertaining content with advertising content embedded in it such that the advertising content is contextually related to the information gathered from the corresponding user.

According to some embodiments of the invention, the data processing system of comprises a mind challenging interactive game and wherein the advertisement derives from the representation and arrangement of the entertainment content.

According to some embodiments of the invention, the mediator server 200 is further configured to retrieve data relating to user's operations relating to said multimedia vehicle, to an advertiser computer (not shown).

According to some embodiments of the invention, the mediator server 200 is configured to provide advertisers with reports pertaining to the users operation in regards to the relevant advertisement.

According to some embodiments of the invention, the mediator server 200 is coupled to the user client computers via the Internet.

According to some embodiments of the invention the user client computers 240 may be in the form of PC, Lap-Tops, Cellular phones, PDA multimedia terminals and the like.

According to some embodiments of the invention, the multimedia vehicle comprises a versatile and modular GUI that is configurable via the mediator server 200.

According to some embodiments of the invention, the mediator server may enable the users to pay via premium SMS, their phone bill, credit card and any electronically available billing method.

According to some embodiments of the invention, the mediator server resides within an existing cellular phone and serves, inter alia, as its billing system.

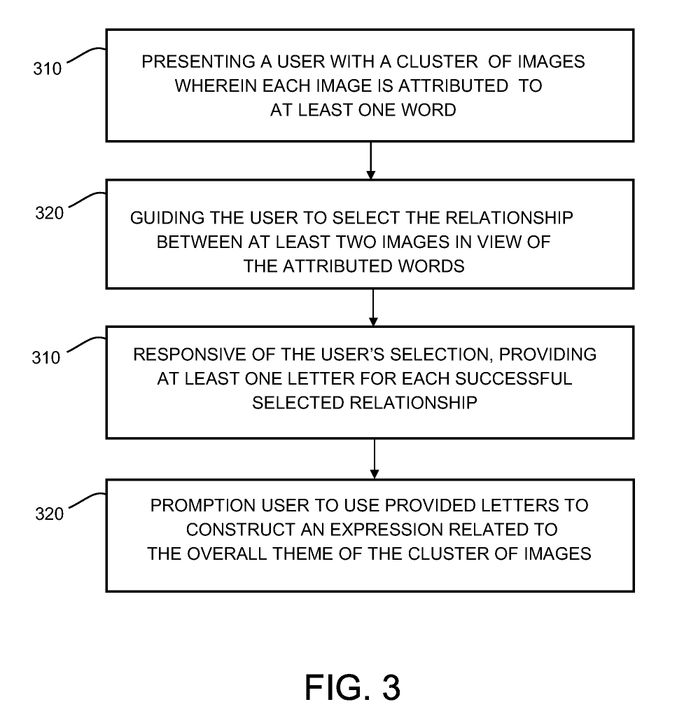

FIG. 3 illustrates an exemplary interactive game that may be used in accordance with the present invention. The interactive game comprises the stage of presenting a user with a cluster of images wherein each image is attributed to at least one word 310, the stage of guiding the user to select the relationship between at least two images in view of the attributed words 320, the stage of providing at least one letter for each successful selected relationship responsive of the user's selection 330, the stage of providing at least one letter for each successful selected relationship 340 and the stage of prompting user to use provided letters to construct an expression related to the overall theme of the cluster of images.

For example, presenting a sequence of images, each showing the cover page of a magazine, wherein each cover present a different movie star. The user is required to find the relationship between two adjacent movie stars and thereby proceed with the game. The user is thus implicitly exposed to the specific magazine.

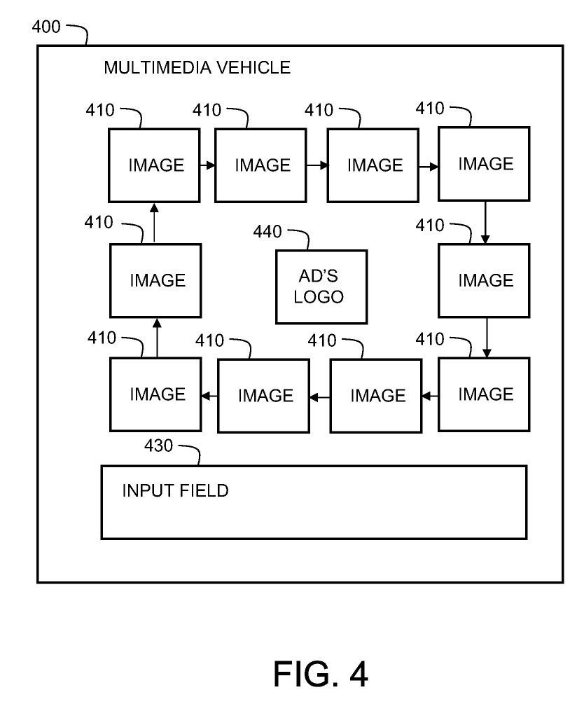

FIG. 4 illustrates an exemplary layout of the multimedia vehicle according to some embodiments of the invention. The multimedia vehicle 400 is a multimedia graphical user interface that is generic for a plurality of different entertaining content usages and is configurable to match a variety of implicit advertising schemes. The multimedia vehicle 400 comprises dedicated fields 410 for the entertainment and below the line (BTL) advertising content that may be provided by the advertiser and may be related with advertising business message targeting to the specific audience.

The user is provided with an input field 420 enabling the interface for participating I the game. The input field 420 may be provided by the advertiser and may be related with advertising business message targeting to the specific audience as well. It may also serve as another means of tracking and extracting relevant information relating to the user.

According to another embodiment, implicit educational scheme may also be implemented by the multimedia vehicle. As mentioned above, FIG. 4 further illustrates how the same multimedia vehicle 400 may be arranged an designed in a generic manner so to support educational content usages as well as business and advertisement schemes, and is configurable to match a variety of implicit education schemes. Thus, the multimedia vehicle 400 comprises dedicated fields 410 for the entertainment and below the line (BTL) education content that may be provided by the educator and may be related with any education message targeting to the specific audience. The user is provided with an input field 420 enabling the interface for participating in the game. The input field 420 may be provided by the educator and may be related with any education message targeting to the specific audience as well.

According to some embodiments of the invention, the multimedia vehicle 400 is provided as a generic platform to the advertiser who subsequently embed the relevant tacit advertisement into the entertainment content and therefrom to the multimedia vehicle 400.

According to some embodiments of the invention, the system can be implemented in digital electronic circuitry, or in computer hardware, firmware, software, or in combinations of them. Apparatus of the invention can be implemented in a computer or in a cellular phone program (software) product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs (software) that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform (software) a certain activity or bring about a certain result. A computer program (software) can be written in any form of programming language, (any kind of software that may be available in the future) including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer or cell phone keyboard, joystick or any other relevant device.

The invention can be implemented in a computer system that includes a back-end component, such as a data server, or that includes a middleware component, such as an application server or an Internet server, or that includes a front-end component, such as a client computer or cell phone having a graphical user interface or an Internet browser, or any other useful software application, or any combination of them. The components of the system can be connected by any form or medium of digital data communication such as a communication network. Examples of communication networks include, e.g., a LAN, a WAN, and the computers and networks forming the Internet and wireless network as well.

The computer system can include multimedia clients and servers. A client and server are generally remote from each other and typically interact through a network, such as the described one. The relationship of multimedia client and server arises by virtue of computer programs or any software running on the respective computers or any hardware and having a client-server relationship to each other.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is

1. A data processing system for delivering entertainment-enhanced content-related advertisement over multimedia networks, said data processing system comprising:
a mediator server comprising a user related information database and an advertising embedded entertainment database; coupled to
a plurality of user client multimedia devices;
wherein said mediator server is configured to gather information related to a user initiating an entertainment request wherein said request is responsive to a pre arranged message;
and wherein said mediator server is further configured to match the optimal advertising embedded entertainment from the advertising embedded entertainment database in view of the specific user related information from the user related information database, and present said advertising embedded entertainment to the user over said user client multimedia devices.

2. The data processing system of claim 1, wherein the entertainment content comprises an interactive game and wherein the advertisement derives from the representation and arrangement of the entertainment content

3. The data processing system of claim 2, wherein said mediator server is further configured to retrieve user related information from the user during the game

4. The data processing system of claim 1, wherein the mediator server is configured to provide advertisers with reports pertaining to the users operation in regards to the relevant advertisement.

5. The data processing system of claim 1, wherein the mediator server is coupled to the user client computers via the Internet.

6. The data processing system of claim 1, wherein the multimedia devices comprise at least one of the following: PC, Lap-Tops, Cellular phones, PDA multimedia terminals.

7. The data processing system of claim 1, wherein the multimedia vehicle comprises a versatile and modular GUI that is configurable via the mediator server.

8. A computer implemented method for delivering entertainment-enhanced content-related advertisement over multimedia networks, said computer implemented method comprising:
encouraging a user to participate in a mind challenging entertaining activity;
gathering user-related characteristic information responsive to the user's initiation of communication;
presenting mind challenging entertaining content to the user such that it embeds a predefined advertising
gathering further information while the user is engaged with the mind challenging entertaining content.

9. The computer implemented method of claim 8, wherein the advertisement content is contextually related to the entertainment content.

10. The computer implemented method of claim 8, wherein the entertainment content comprises an interactive game.

11. The computer implemented method of claim 10, wherein said interactive game comprises:
presenting a user with a cluster of images wherein each image is attributed to at least one word;
guiding the user to select the relationship between at least two images in view of the attributed words;
responsive of the user's selection, providing at least one letter for each successful selected relationship;
prompting user to use provided letters to construct an expression related to the overall theme of the cluster of images.

12. The computer implemented method of claim 8, wherein presenting users with said entertainment content having the advertisement content embedded thereto is followed by tracking the user's activity in regards to the entertainment content.

13. The computer implemented method of claim 12, wherein tracking the user's activity in regards to the entertainment content is followed by generating reports relating to the user's activities.

14. A computer program product for delivering entertainment-enhanced content-related advertisement over multimedia networks, said computer program product comprising:
a computer usable medium having computer usable program code tangibly embodied thereon, the computer usable program code comprising:
a computer usable program code for encouraging a user to participate in a mind challenging entertaining activity;
a computer usable program code for gathering user related information responsive of the user's initiation of communication;
a computer usable program code for presenting mind challenging entertaining content to the user such that the entertainment embeds a predefined advertising in accordance with the gathered user related information.
a computer usable program code for further gathering user related information while the user is engaged with the mind challenging entertaining content.

15. The computer program product of claim 14, wherein the advertisement content is contextually related to the entertainment content.

16. The computer program product of claim 14, wherein the entertainment content comprises an interactive game.

17. The computer program product of claim 16, wherein the interactive game comprises:
a computer usable medium having computer usable program code tangibly embodied thereon, the computer usable program code comprising:
a computer usable program code for presenting a user with a cluster of images wherein each image is attributed to at least one word;
a computer usable program code for guiding the user to select the relationship between at least two images in view of the attributed words;
a computer usable program code for responsive of the user's selection, providing at least one letter for each successful selected relationship;
a computer usable program code for prompting user to use provided letters to construct an expression related to the overall theme of the cluster of images.

18. The computer program product of claim 14, further comprising a computer usable program code for tracking the user's activity in regards to the entertainment content.

19. The computer program product of claim 14, further comprising a computer usable program code for generating reports relating to the user's activities.
